(19) United States
(12) Patent Application Publication
(10) Pub. No.: US 2010/0009686 A1
(43) Pub. Date: Jan. 14, 2010

(54) METHOD AND ARRANGEMENT FOR HANDLING NEIGHBOURING CELL LISTS IN A COMMUNICATION SYSTEM

(75) Inventor: Harald Kallin, Sollentuna (SE)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON (PUBL), Stockholm (SE)

(21) Appl. No.: 12/524,636

(22) PCT Filed: Feb. 9, 2007
(86) PCT No.: PCT/EP07/51293

§ 371 Date: Jul. 27, 2009

(51) Int. Cl. H04W 40/00

(52) U.S. Cl. 455/446

(57) ABSTRACT

The present invention relates to a method and an arrangement for handling neighbouring cell lists when a new radio base station (15e) is introduced into a communication network, said neighbouring cell lists being used for facilitating handover of one or more user equipments moving between cells (A, B, C, E), each being served by a radio base station (15a-c) in said communication network, and performing measurements upon which said neighbouring cell lists are based. The new radio base station (15e) is initially turned on on a low output power, whereby said user equipments are given an opportunity to detect said new radio base station (15e) and update neighbouring cell lists of radio base stations (15a-c) surrounding said new radio base station (15e) and also to create a neighbouring cell lists for said new radio base station (15e), without having to make a handover to said new radio base station (15e). Then, over time, said output power of said new radio base station (15e) is slowly increased until it has reached a pre-defined output power and has become a handover candidate in said neighbouring cell lists of radio base stations (15a-c) surrounding said new radio base station (15e).

### TECHNICAL FIELD

The present invention relates to a method and an arrangement in a communication network, and particularly, to an arrangement allowing for handling neighbouring cell lists when a new radio base station is introduced into a communication network as well as a method for such handling. The invention also relates to a radio base station and a user equipment for handling neighbouring cell lists when the radio base station is introduced into a communication network. The invention further relates to a computer-readable medium containing computer program for handling neighbouring cell lists when a new radio base station is introduced into a communication network.

### BACKGROUND OF THE INVENTION

In a typical cellular radio system, mobile user equipments (UEs) communicate via a radio access network (RAN) to one or more core networks (CN). The radio access network covers a geographical area which is divided into cell areas, with each cell being served by a radio base station. Each radio base station, however, may serve more than one cell and cells being served by the same radio base station form a cell site. In order to maintain a radio connection with the network, the user equipments are handed over from one cell to the next when travelling through the geographical area. To facilitate handovers in cellular systems, the neighbouring cells concept is introduced and is well known from the early days.

One purpose of neighbouring cells is to have a limited, predefined set of cells that makes the measurement and processing task easier for the user equipments and provides better measurement accuracy, as more measurement samples can be taken on the predefined set of neighbouring cells. Another purpose is to have a set of rules for neighbour cell relations that govern the handovers, for example thresholds, restrictions or timers.

Already in those early days, operators had problems defining neighbouring cells in a proper way. Neighbours that should have been included were not, neighbours that shouldn't be included were so. Going from sparse frequency reuse schemes, into one-cell reuse, makes the need for proper neighbouring cell lists more crucial, since reusing all frequencies in all cells makes the system much less forgiving to being connected to the wrong cell than before.

Since the cellular networks are constantly growing, adding cells is an ever ongoing process; not only adding the new cell to existing neighbouring cell lists, but also remove obsolete definitions that no longer are required. Adding new relations can be a rather slow process, where the system needs to judge additions and removal of cell relations over long periods of time before making a decision. The time period is hours or days, rather than seconds or minutes. When a new cell is introduced in a wireless network, it may cause dramatic adverse effects on the surrounding cells' performance if not all necessary network configuration changes are made at the same time. Such simultaneousness requires operator planning and is not an option for autonomous learning systems.

Manual planning of neighbouring cells is resource intensive and is error prone. Mistakes in the neighbouring cell planning may cause impaired connection quality and dropped calls, and poorly maintained neighbour cell lists is often the major cause for dropped calls in cellular network.

Neighbouring cells are not static, and they need to change due to changes in the cellular network radio design; changes in the end user behavior or even changes in the building infrastructure may raise a need for changes in the neighbouring cell lists.

One prior art approach is shown in U.S. Pat. No. 5,854,981, which discloses a method and an apparatus for adaptively reconfiguring a neighbour cell list. Measurements are performed by the mobile station and by the base station for handling the neighbour cell lists.

Thus, methods for creating automatic neighbouring cell lists is previously known. What is missing is a method for introducing a new cell without any prior configuration.

### SUMMARY OF THE INVENTION

Accordingly, it is an objective with the present invention to provide an improved method for handling neighbouring cell lists when introducing a new radio base station in a communication network comprising a plurality of radio base stations serving cells between which one or more user equipments are moving and performing measurements upon which said neighbouring cell lists are based.

According to a first aspect of the present invention this objective is achieved through a method as defined in the characterising portion of claim 1, which specifies that the handling of neighbouring cell lists when a new radio base station is introduced into a communication network is controlled by a method comprising the steps of over time gradually increasing an output power from an initial value of said new radio base station such that said user equipments will detect it and initiate neighbouring cell lists updatings.

Another objective with the present invention is to provide an improved arrangement for handling neighbouring cell lists when introducing a new radio base station in a communication network comprising a plurality of radio base stations serving cells between which one or more user equipments are moving and performing measurements upon which said neighbouring cell lists are based.

According to a second aspect of the present invention this other objective is achieved through an arrangement as defined in the characterising portion of claim 9, which specifies that the handling of neighbouring cell lists when a new radio base station is introduced into a communication network is controlled by an arrangement comprising means for over time gradually increasing an output power from an initial value of said new radio base station such that said user equipments will detect it and initiate neighbouring cell lists updatings.

A further objective with the present invention is to provide an improved radio base station for handling neighbouring cell lists when being introduced in a communication network comprising a plurality of radio base stations serving cells between which one or more user equipments are moving and performing measurements upon which said neighbouring cell lists are based.

According to a third aspect of the present invention this further objective is achieved through a radio base station as defined in the characterising portion of claim 17, which specifies that the handling of neighbouring cell lists when the new radio base station is introduced into a communication network is controlled by a new radio base station comprising means for over time gradually increasing an output power from an initial value of said new radio base station such that said user equipments will detect it and initiate neighbouring cell lists updatings

A still further objective with the present invention is to provide an improved user equipment for handling neighbouring cell lists when introducing new radio base stations in a communication network comprising a plurality of radio base stations serving cells between which said user equipment is moving and performing measurements upon which said neighbouring cell lists are based.

According to a fourth aspect of the present invention this further objective is achieved through a user equipment as defined in the characterising portion of claim 18, which specifies that the handling of neighbouring cell lists when the new radio base station is introduced into a communication network is controlled by that said user equipment is arranged to detect a new radio base station and initiate neighbouring cell lists updatings.

A yet further objective with the present invention is to provide an improved computer-readable medium containing computer program for handling neighbouring cell lists when introducing a new radio base station in a communication network comprising a plurality of radio base stations serving cells between which one or more user equipments are moving and performing measurements upon which said neighbouring cell lists are based.

According to a fifth aspect of the present invention this further objective is achieved through a computer-readable medium as defined in the characterising portion of claim 19, which specifies that the handling of neighbouring cell lists when a new radio base station is introduced into a communication network is controlled by a computer program performing the steps of over time gradually increasing an output power from an initial value of said new radio base station such that said user equipments will detect it and initiate neighbouring cell lists updatings.

Further embodiments are listed in the dependent claims.

Thanks to the provision of a method and an arrangement, which create new—and update existing—neighbouring cell lists in a structured way when a new cell is introduced in an existing radio network, the planning burden from the network operator is alleviated when introducing new cells which allows automatic neighbouring cell lists to be created even with no prior knowledge of neighbours; with a minimal negative impact on the end users and system performance.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 shows the communication network architecture according to the present invention;

FIG. 2 illustrates how a new cell is introduced in a wireless network according to the preferred embodiment of the present invention;

FIGS. 3a-3d illustrates how a new radio base station site with three cells is introduced in an existing wireless network according to the preferred embodiment of the present invention;

FIG. 4 shows how the output power of a new radio base station is ramped over time in a generalized fashion;

FIG. 5 shows a computer-readable medium.

### DETAILED DESCRIPTION OF PREFERRED EMBODIMENTS

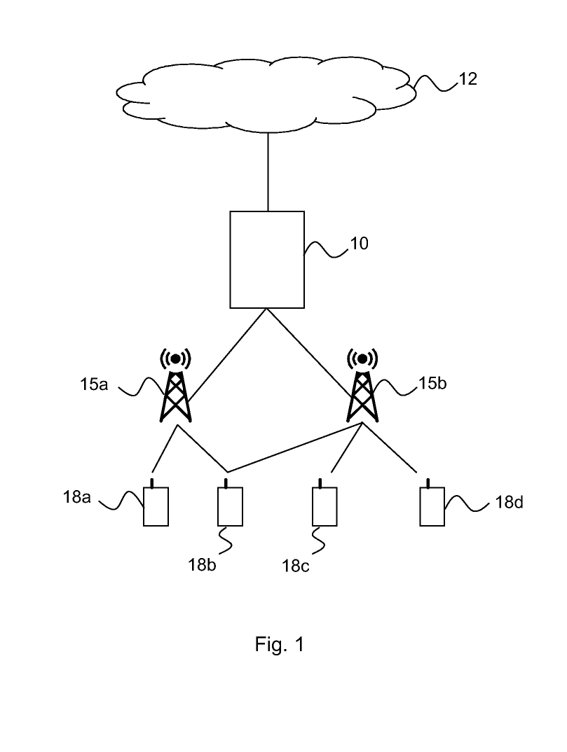

FIG. 1 depicts a communication system, such as a Wideband Code Division Multiple Access (WCDMA) system, including a Radio Access Network (RAN), such as the UMTS Terrestrial Radio Access Network (UTRAN) architecture, comprising at least one Radio Base Station (RBS) (or Node B) 15a-b, connected to one or more Radio Network Controllers (RNCs) 10 (only one shown in FIG. 1). The RAN is connected over an interface such as the lu-interface to a Core network (CN) 12, which may be a connection-oriented external CN such as the Public Switched Telephone Network (PSTN) or the Integrated Services Digital Network (ISDN), and/or a connectionless external CN as the Internet.

The RAN and the CN 12 provide communication and control for a plurality of user equipments (UE) 18a-d. The UEs 18 each uses downlink (DL) channels (i.e. base-to-user or forward) and uplink (UL) channels (i.e. user-to-base or reverse) to communicate with at least one RBS 15 over a radio or air interface. On the downlink channel, the RBS 15 transmits data to each user equipment 18 at respective power level. On the uplink channel, the user equipments 18 transmit data to the RBS 15 at respective power level. As illustrated in FIG. 1, in WCDMA when performing a handover the UE 18b continues to communicate with the communication system via the old RBS 15a at least until a dedicated radio channel is established also to the new RBS 15b.

According to a preferred embodiment of the present invention, the communication system is herein described as a WCDMA communication system. The skilled person, however, realizes that the inventive method and arrangement works very well on all communications system, such as the Global System for Mobile communications (GSM) or Long Term Evolution (LTE) system. The user equipments 18 may be mobile stations such as mobile telephones (“cellular” telephones) and laptops with mobile termination and thus can be, for example, portable, pocket, hand-held, computer-included or car-mounted mobile devices which communicate voice and/or data with the RAN.

The present invention teaches a method where the output power of a new cell is increased over time, so that it—and its neighbours—can create and update the neighbour cell lists, with a minimal impact on the service performance for the end users.

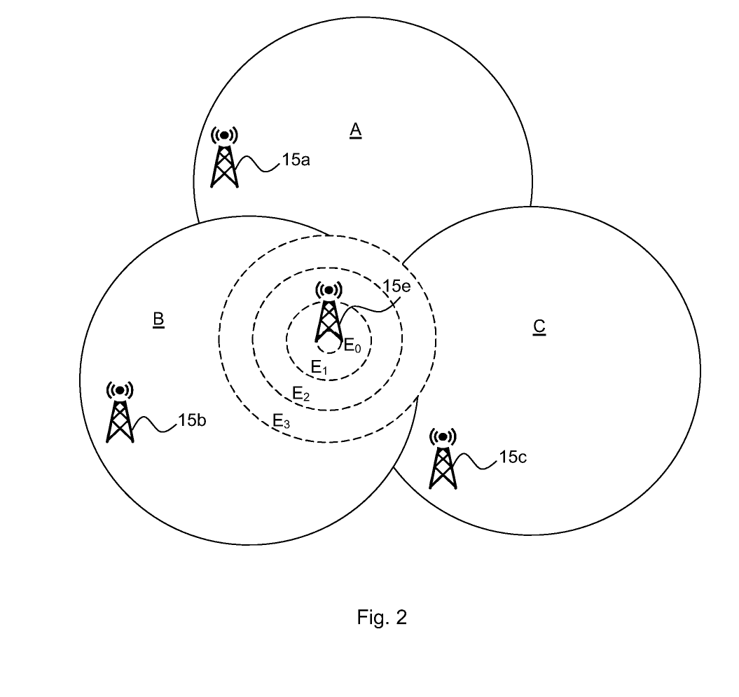

FIG. 2 illustrates how a new cell E is introduced in a wireless network comprising three radio base stations 15a-c each serving a cell A-C respectively. First, when the radio base station 15e is installed, at to, it is allowed to transmit with a low power level P₀ leading to a traffic pickup area E₀. Over time the power level of the new radio base station 15e is gradually ramped until a pre-defined or maximum power level is reached. The user equipments travelling through the cells (not shown in FIG. 2) are capable of performing measurements of surrounding cells and report the signal strength and some cell identity, to the cell which is currently serving the end user. Such functionality is available in systems like GSM and WCDMA and will be available in LTE and other future systems as well. The user equipments are also capable of performing measurements of more surrounding cells (more distant, weaker) than is really needed at the current position. By using the power ramping approach, the user equipments are given an opportunity to detect (measure) new cells without needing to make a handover to them and, thus, the neighbour cell list is updated with the new detected cell. Over time, the cell border is moving forward and the traffic pickup area is growing from E₀ to E₃. These relations are illustrated in the table below, i.e. how the number of cells detected and the number of cells needed for handover increases (in slightly different rate) when the power level is ramped over time.

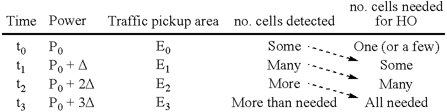

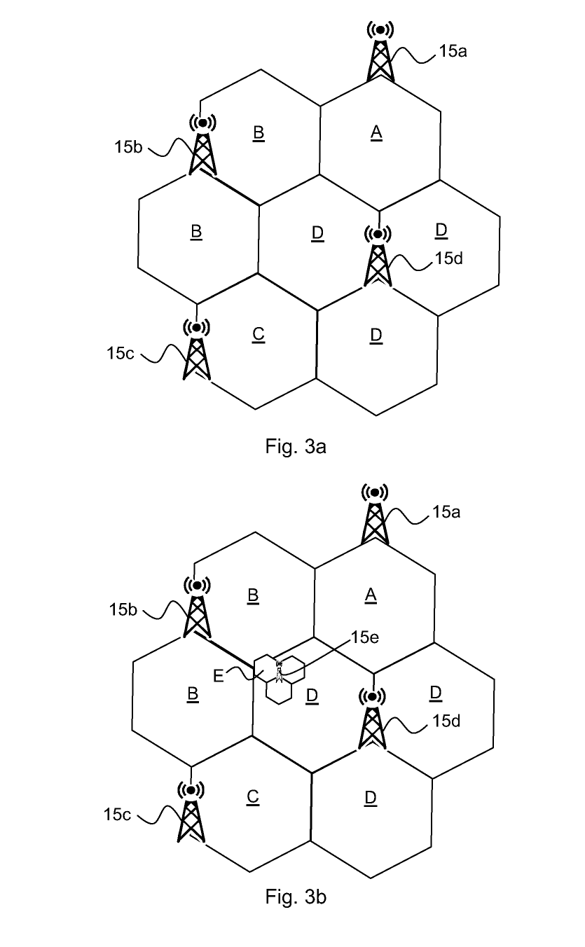

FIGS. 3a-3d illustrates the situation where a new radio base station site with three cells E is introduced in an existing wireless network comprising four radio base station sites A-D. For the reason of simplicity, only parts of the sites A-C are shown in FIGS. 3a-3d. Also, it is understood that the wireless network may comprise many more sites than four. It is vital for all the cells to get proper, mutual, definitions to the new cells. Until these are established, users moving between for instance cells B and cells D will run the risk of dropping the connection since they cannot hand over to the new cell. The same problem goes for users moving from cells C to cells A, and vice versa. And it is also true for users connecting to the new cells and is moving away from them.

This adverse effect from starting the new cells without neighbour cell definitions in place is proportional to the size of the new cells; the larger the new cells are, the more users will be affected.

A solution to this problem is, as explained above, to slowly increase the output power of the new cells, instead of immediately allow their maximum power.

Thus, the existing network is shown in FIG. 3a, in which four radio base station sites A-D are shown, each served by a radio base station 15a-d. User equipments (not shown) travelling through the cells perform measurements of surrounding cells and report the signal strength and some cell identity, to the RBS 15 which is currently serving. When the new site is initially turned on, shown in FIG. 3b, only a small number of end users will lock on to this new site, and only a small fraction of the end users would need to perform a handover to or from them (which might fail since they are not defined as neighbours). But a larger amount of end users will be able to detect their presence and report this to their current serving cell (A-D), without having a desire or urgent need to handover to or from the new cells.

When the new cells are small (primarily in the initial phases), it is even possible that an end user may be able to pass through the new cells quickly without handing over to them, and instead handing over to an old established neighbour; only causing some disturbances for the end user for a few seconds.

As time passes, shown in FIG. 3c, the live traffic will continuously produce more measurement samples which will be collected by the wireless system, where it is used to determine if a neighbouring cell relation exists. Just because another neighbouring cell is detected in the measurements, does not necessarily mean the cell is a handover candidate. To be a handover candidate, the neighbour typically needs to be the very strongest neighbour, something that may not happen (or only happen very rarely). When a detected cell is also identified to be able to be the very best server, it may be added to the neighbouring cell list for the serving (new) cell E. The serving cell E may inform the neighbouring cell (e.g. the cell A) that it is added to the neighbouring list of the new cell E, and that the neighbour may wish to do the same (add the new cell E as a neighbour). Or, one may rely on that the cell A will detect the new cell in the very same way. Cell E and cell A may also add (and possibly exchange/negotiate/agree upon) other handover parameters like signal strength hysteresis, filter times et cetera.

Once the relations between the new cell E and cells B and D exist, in FIG. 3d, the life for the end users in cells C and cells A become somewhat safer. Even if the new cell E is not yet defined as a neighbour to the cell C; an end user traveling from the cell C to the cell A has a decent chance of surviving a trip into cell E territory. When leaving the cell C, the end user can be handed over to e.g. the cell D, which in turn can rapidly hand over the user to the new cell E for a continued safe trip.

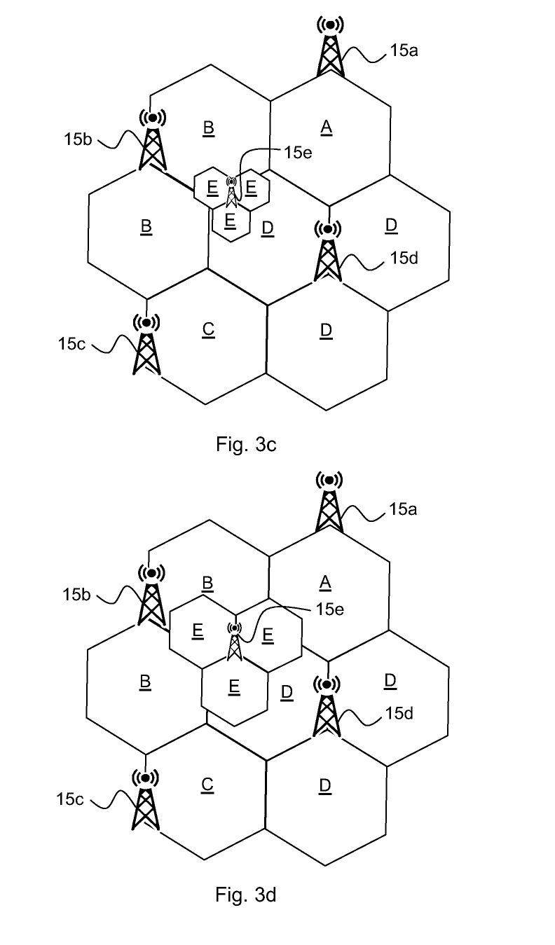

There are different ways of implementing the base station output power increase over time. The rate of increase should be selected to be slower than the rate of the automatic neighboring cell list process. FIG. 4 shows examples of different ways to increase the radio base station output power over time; in a logarithmic way (shown with a dashed line), a linear way (shown with a solid line) and an exponential way (shown with a dash dotted line).

The output power increase is primarily related to the output power of the beacon or channel that the mobile stations use for detecting a neighbouring cell. It may be advantageous to let the output power of traffic channels and the end user equipment to ramp in a similar fashion.

The output power increase is typically stopped when the power level reaches its pre-defined level. Alternatively, by observing the cell performance, the power increase may be stopped earlier (or later). If the number of neighbour cell relations established is above a pre-defined level before the final power level is reached, the power increase could be halted as this may indicate that making the new cell even larger will risk to interfere too much with its adjacent cells. Another reason for stopping the power ramping prematurely is if the traffic ontake for the new cell (or the number of simultaneous users camping on the cell) is above a threshold that corresponds to its traffic handling capabilities. A further reason for stopping the power ramping is when interference in adjacent/surrounding cells has increased above a pre-defined level

The maximum output power of the user equipment is defined by parameters sent from the cell to the user equipment. It can be advantageous to let the maximum output power of the user equipments follow the cell output power in a similar fashion, so that the user equipment in a tiny cell is not operating on excessive power levels that may cause interference to other cells.

It will be appreciated that at least some of the procedures described above are carried out repetitively as necessary to respond to the time-varying characteristics of the channel between the transmitter and the receiver. To facilitate understanding, many aspects of the invention are described in terms of sequences of actions to be performed by, for example, elements of a programmable computer system. It will be recognized that the various actions could be performed by specialized circuits (e.g. discrete logic gates interconnected to perform a specialized function or application-specific integrated circuits), by program instructions executed by one or more processors, or a combination of both.

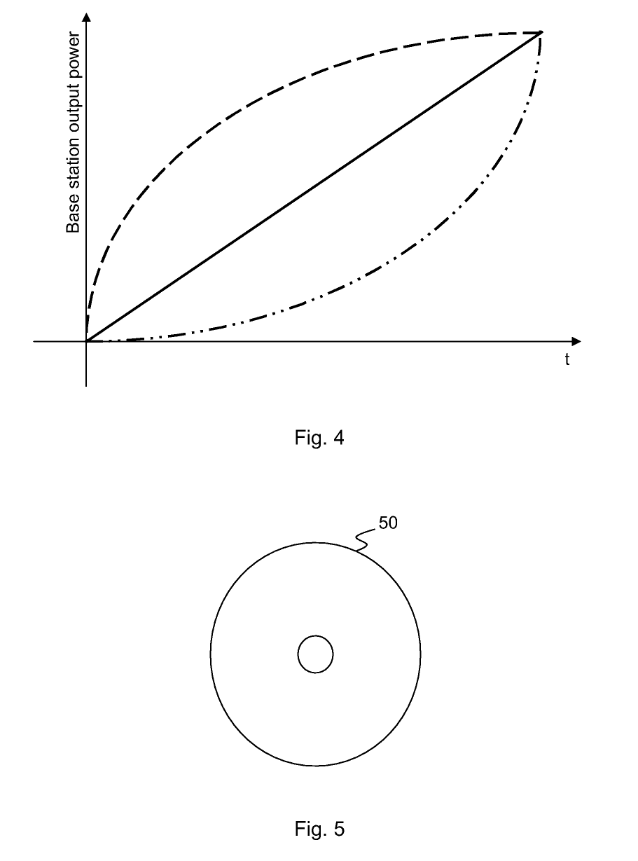

Moreover, the invention can additionally be considered to be embodied entirely within any form of computer-readable storage medium, an example of which is shown in FIG. 5 and denoted 50, having stored therein an appropriate set of instructions for use by or in connection with an instruction-execution system, apparatus or device, such as computer-based system, processor-containing system, or other system that can fetch instructions from a medium and execute the instructions. As used here, a “computer-readable medium” 50 can be any means that can contain, store, communicate, propagate, or transport the program for use by or in connection with the instruction-execution system, apparatus or device. The computer-readable medium 50 can be, for example but not limited to, an electronic, magnetic, optical, electromagnetic, infrared, or semiconductor system, apparatus, device or propagation medium. More specific examples (a non-exhaustive list) of the computer-readable medium include an electrical connection having one or more wires, a portable computer diskette, a random access memory (RAM), a read only memory (ROM), an erasable programmable read only memory (EPROM or Flash memory), an optical fibre, and a portable compact disc read only memory (CD-ROM).

Thus, a computer-readable medium containing computer program according to a preferred embodiment of the present invention for handling neighbouring cell lists when a new radio base station is introduced into a communication network, said neighbouring cell lists being used for facilitating handover of one or more user equipments moving between cells, each being served by a radio base station in said communication network, and performing measurements upon which said neighbouring cell lists are based, wherein the computer program performs the step of: over time gradually increasing an output power from an initial value of said new radio base station such that said user equipments will detect it and initiate neighbouring cell lists updatings. The gradual increase may be implemented as a number of discrete steps

Modifications to embodiments of the invention described in the foregoing are possible without departing from the scope of the invention as defined by the accompanying claims.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural and vice versa.

Numerals included within parentheses in the accompanying claims are intended to assist understanding of the claims and should not be construed in any way to limit subject matter claimed by these claims.

1. A method for handling neighboring cell lists when introducing a new radio base station in a communication network, the communication network comprising a plurality of radio base stations serving cells between which one or more user equipment are moving and performing measurements upon which said neighboring cell lists are based, the method comprising:
setting an output power of the new radio base station to an initial value; and
gradually increasing, over time, the output power of the radio base station from the initial value such that said one or more user equipment will detect the new radio base station and initiate neighboring cell lists updatings.

2. A method according to claim 1, where said one or more user equipment further will initiate a creation of a neighboring cell list in said new radio base station.

3. A method according to claim 1, where said increase of said output power is done in at least one of the following ways: logarithmic, linear or exponential.

4. A method according to claim 1, further comprising:
terminating said increase of said output power when a pre-defined power level has been reached.

5. A method according to claim 1, further comprising:
terminating said increase of said output power when a number of established neighbor cell relations is above a pre-defined level.

6. A method according to claim 1, further comprising:
terminating said increase of said output power when handling of traffic in the cell served by the new radio base station has reached a pre-defined threshold value corresponding to traffic handling capabilities of the cell.

7. A method according to claim 1, further comprising:
terminating said increase of said output power when interference in surrounding cells has increased above a pre-defined level.

8. A method according to claim 1, where a maximum output power of the user equipment in the new cell, supported by the new radio base station, is increased in a corresponding way as the output power of said new radio base station.

9. An arrangement for handling neighboring cell lists when introducing a new radio base station in a communication network, the communication network comprising a plurality of radio base stations serving cells between which one or more user equipment are moving and performing measurements upon which said neighboring cell lists are based, the arrangement comprising:
means for setting an output power of the new radio base station to an initial value; and
means for gradually increasing, over time, the output power of the new radio base station from the initial value such that said user equipment will detect the new radio base station and initiate neighboring cell lists updatings.

10. An arrangement according to claim 9, where said user equipment further is arranged to initiate a creation of a neighboring cell list in said new radio base station.

11. An arrangement according to claim 9, where said means for gradually increasing, over time, the output power is arranged to increase said output power in at least one of the following ways: logarithmic, linear or exponential.

12. An arrangement according to claim 9, further comprising:
means for terminating said increase of said output power when a predefined power level has been reached.

13. An arrangement according to claim 9, further comprising:
means for terminating said increase of said output power when a number of established neighbor cell relations is above a pre-defined level.

14. An arrangement according to claim 9, further comprising:
means for terminating said increase of said output power when a handling of traffic in the cell, served by the new radio base station, has reached a pre-defined threshold value corresponding to traffic handling capabilities of the cell.

15. An arrangement according to claim 9, further comprising:
means for terminating said increase of said output power when interference in surrounding cells has increased above a pre-defined level.

16. An arrangement according to claim 9, where a maximum output power of the user equipment in the new cell, served by the new radio base station, is arranged to increase in a corresponding way as the output power of said new radio base station.

17. A radio base station for handling neighboring cell lists when being introduced in a communication network, the communication network comprising a plurality of radio base stations serving cells between which one or more user equipment are moving and performing measurements upon which said neighboring cell lists are based, said radio base station comprising:
means for setting an output power of the radio base station to an initial value; and
means for gradually increasing, over time, the output power of the radio base station from the initial value such that said user equipment will detect the radio base station and initiate neighboring cell lists updatings.

18. A user equipment (18) for handling neighboring cell lists when introducing new radio base stations in a communication network, the communication network comprising a plurality of radio base stations serving cells between which said user equipment is moving and performing measurements upon which said neighbouring cell lists are based, said user equipment is to:
detect a new radio base station, and
initiate neighboring cell lists updatings in response to detecting the new radio base station.

19. A computer-readable medium containing computer program instructions for handling neighboring cell lists when introducing a new radio base station in a communication network, the communication network comprising a plurality of radio base stations serving cells between which one or more user equipment are moving and performing measurements upon which said neighboring cell lists are based, the computer program instructions, when executed, cause a method to be performed that includes:
setting an output power of the new radio base station to an initial value; and
gradually increasing, over time, the output power of the new radio base station from the initial value of said new radio base station such that said user equipment will detect the new radio base station and initiate neighboring cell lists updatings.
